(19) United States
(12) Patent Application Publication
(10) Pub. No.: US 2018/0176632 A1
(43) Pub. Date: Jun. 21, 2018

(54) SCREEN CONTROL METHOD AND ELECTRONIC DEVICE SUPPORTING THE SAME

(71) Applicant: SAMSUNG ELECTRONICS CO., LTD., Suwon-si (KR)

(72) Inventors: Sul Hee YANG, Seoul (KR); Sung Hyuk KWON, Suwon-si (KR); Chun RYU, Gwangju (KR); Jang Won SEO, Seoul (KR)

(73) Assignee: SAMSUNG ELECTRONICS CO., LTD., Suwon-si (KR)

(21) Appl. No.: 15/848,773

(22) Filed: Dec. 20, 2017

(30) Foreign Application Priority Data
Dec. 20, 2016 (KR) 10-2016-0174980

(51) Int. Cl. H04N 21/431; G06F 3/038; H04N 21/41; G06F 3/0481

(52) U.S. Cl. CPC H04N 21/4312; G06F 3/0481; H04N 21/4122; G06F 3/038

(57) ABSTRACT

An electronic device is provided. The electronic device includes a first interface for connection to a first external device, a second interface for connection to a second external device, a display, a memory, and a processor. The memory stores instructions that, when executed, cause the processor to receive a first source input from the first external device through the first interface, output a first screen corresponding to the first source input on the display, if a request for switching from the first interface to the second interface is received, output a second screen related to switching to the second external device on the display, and if a first time point at which a second source input is received from the second external device through the second interface comes, output a third screen corresponding to the second source input on the display.

### CROSS-REFERENCE TO RELATED APPLICATION(S)

This application claims the benefit under 35 U.S.C. § 119(a) of a Korean patent application filed on Dec. 20, 2016 in the Korean Intellectual Property Office and assigned Serial number 10-2016-0174980, the entire disclosure of which is hereby incorporated by reference.

### TECHNICAL FIELD

The disclosure relates to a screen control method and an electronic device supporting the same.

### BACKGROUND

In recent years, thanks to the development of the digital technologies, various types of electronic products have been developed and distributed, and as the electronic products have multiple functions, products by which various services may be provided with one device have appeared.

Further, due to the development of the communication technologies, various services have been provided through interworking systems between electronic devices. In particular, the electronic devices, such as digital TVs, may perform a function of receiving a broadcasting signal through an antenna or the like and providing a screen of various broadcasting channels to the user and a function of providing a screen corresponding to source inputs received from various external devices, such as a smartphone, a set-top box, or a game console, by connecting the electronic devices to the external devices.

### SUMMARY

The electronic devices that are connected to the plurality of external devices to provide a screen corresponding to source inputs received from the external devices generates a phenomenon in which a time gap during which the source inputs are switched occurs and the screen is cut off as in a black screen when one external device is switched to another external device.

Embodiments of the present disclosure provide a screen control method that provides a screen related to switching to an external device while source inputs are switched, and an electronic device supporting the same.

In accordance with an aspect of the present disclosure, an electronic device includes a first interface for connection to a first external device, a second interface for connection to a second external device, a display configured to output a screen, a memory configured to store information for constituting the screen, and a processor electrically connected to the first interface, the second interface, the display, and the memory. The memory stores instructions that, when executed, cause the processor to receive a first source input from the first external device through the first interface, output a first screen corresponding to the first source input on the display, if a request for switching from the first interface to the second interface is received, output a second screen related to switching to the second external device on the display, and if a first time point at which a second source input is received from the second external device through the second interface comes, output a third screen corresponding to the second source input on the display.

In accordance with another aspect of the present disclosure, an electronic device includes a first interface for connection to a first external device, a second interface for connection to a second external device, a third interface for connection to a third external device, a display configured to output a screen, a memory configured to store information for constituting the screen, and a processor electrically connected to the first interface, the second interface, the third interface, the display, and the memory. The memory stores instructions that, when executed, cause the processor to receive a first source input from the first external device through the first interface, output a first screen corresponding to the first source input on the display, if a request for switching from the first interface to another interface that is different from the first interface is received, output a second screen to select one external device of the second external device or the third external device on the display, if a user input for selecting one external device of the second external device or the third external device is received, output a third screen related to switching to the selected one external device on the display, and if a second source input is received from the selected one external device through an interface for connection to the one selected external device, output a fourth screen corresponding to the second source input on the display.

In accordance with another aspect of the present disclosure, a method of controlling a screen of an electronic device includes receiving a first source input from a first external device through a first interface, outputting a first screen corresponding to the first source input on a display, receiving a request for switching to another interface that is different from the first interface, outputting a second screen including a first object for selecting a second external device connected through a second interface and a second object for selecting any one external device of a plurality of third external devices connected through a plurality of third interfaces, respectively, on the display, receiving a first user input for selecting the first object or the second object, if the first user input is an input for selecting the first object, outputting a third screen related to switching to the second external device, and if a first time point at which a second source input is received from the second external device comes, outputting a fourth screen corresponding to the second source input, and if the first user input is an input for selecting the second object, outputting a fifth screen for selecting any one external device of the plurality of third external devices, if a second user input for selecting any one external device of the plurality of third external devices is received, outputting a sixth screen related to switching to one external device selected from the plurality of third external devices, and if a second time point at which a third source input is received from the selected one external device, outputting a seventh screen corresponding to the third source input.

According to the present disclosure, a phenomenon of cutting off a screen may be prevented by providing a screen related to switching to an external device while source inputs are switched, and accordingly, a continuity of the screen may be enhanced and information of the output screen may be provided.

In addition, the present disclosure may provide various effects that are directly or indirectly recognized.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an electronic device related to control of a screen according to an embodiment.

FIG. 2 is a view illustrating a method for managing an electronic device related to control of a screen according to an embodiment.

FIG. 3 is an exemplary view of a screen related to control of a screen according to an embodiment.

FIG. 4 is a view for explaining switching of source inputs according to an embodiment.

FIG. 5 is a view illustrating a screen related to switching to an external device according to an embodiment.

FIG. 6 is a view for explaining a state in which a plurality of external devices are connected according to an embodiment.

FIG. 7 is a view for explaining a screen that is provided according to a state of a source input according to an embodiment.

FIG. 8 is a view for explaining a state in which a setting screen for an external device is provided according to an embodiment.

FIG. 9 is a view for explaining another screen that is provided according to a state of a source input according to an embodiment.

Throughout the drawings, it should be noted that like reference numbers are used to depict the same or similar elements, features, and structures.

### DETAILED DESCRIPTION

Hereinafter, various embodiments of the present disclosure are disclosed with reference to the accompanying drawings. However, the present disclosure is not intended to be limited by the various embodiments of the present disclosure to a specific embodiment and it is intended that the present disclosure covers all modifications, equivalents, and/or alternatives of the present disclosure provided they come within the scope of the appended claims and their equivalents. With respect to the descriptions of the accompanying drawings, like reference numerals refer to like elements.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include,” “comprise,” and “have”, or “may include,” or “may comprise” and “may have” used herein indicates disclosed functions, operations, or existence of elements but does not exclude other functions, operations or elements.

For example, the expressions “A or B,” or “at least one of A and/or B” may indicate A and B, A, or B. For instance, the expression “A or B” or “at least one of A and/or B” may indicate (1) at least one A, (2) at least one B, or (3) both at least one A and at least one B.

The terms such as “1st,” “2nd,” “first,” “second,” and the like used herein may refer to modifying various different elements of various embodiments of the present disclosure, but are not intended to limit the elements. For instance, “a first user device” and “a second user device” may indicate different users regardless of order or importance. For example, a first component may be referred to as a second component and vice versa without departing from the scope and spirit of the present disclosure.

In various embodiments of the present disclosure, it is intended that when a component (for example, a first component) is referred to as being “operatively or communicatively coupled with/to” or “connected to” another component (for example, a second component), the component may be directly connected to the other component or connected through another component (for example, a third component). In various embodiments of the present disclosure, it is intended that when a component (for example, a first component) is referred to as being “directly connected to” or “directly accessed” another component (for example, a second component), another component (for example, a third component) does not exist between the component (for example, the first component) and the other component (for example, the second component).

The expression “configured to” used in various embodiments of the present disclosure may be interchangeably used with “suitable for,” “having the capacity to,” “designed to,” “adapted to,” “made to,” or “capable of” according to the situation, for example. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or application processor (AP)) for performing corresponding operations by executing at least one software program stored in a memory device.

Terms used in various embodiments of the present disclosure are used to describe certain embodiments of the present disclosure, but are not intended to limit the scope of other embodiments. The terms of a singular form may include plural forms unless they have a clearly different meaning in the context. Otherwise, all terms used herein may have the same meanings that are generally understood by a person skilled in the art. In general, terms defined in a dictionary should be considered to have the same meanings as the contextual meaning of the related art, and, unless clearly defined herein, should not be understood differently or as having an excessively formal meaning. In any case, even the terms defined in the present specification are not intended to be interpreted as excluding embodiments of the present disclosure.

An electronic device according to various embodiments of the present disclosure may include at least one of a smartphone, a tablet personal computer (PC), a mobile phone, a video telephone, an electronic book reader, a desktop PC, a laptop PC, a netbook computer, a workstation, a server, a personal digital assistant (PDA), a portable multimedia player (PMP), a Motion Picture Experts Group (MPEG-1 or MPEG-2) Audio Layer 3 (MP3) player, a mobile medical device, a camera, or a wearable device. The wearable device may include at least one of an accessory-type device (e.g., a watch, a ring, a bracelet, an anklet, a necklace, glasses, a contact lens, a head-mounted device (HMD)), a textile- or clothing-integrated-type device (e.g., an electronic apparel), a body-attached-type device (e.g., a skin pad or a tattoo), or a bio-implantable-type device (e.g., an implantable circuit)

In some various embodiments of the present disclosure, an electronic device may be a home appliance. The smart home appliance may include at least one of, for example, a television (TV), a digital video/versatile disc (DVD) player, an audio, a refrigerator, an air conditioner, a cleaner, an oven, a microwave oven, a washing machine, an air cleaner, a set-top box, a home automation control panel, a security control panel, a television (TV) box (e.g., Samsung HomeSync™, Apple TV™, or Google TV™), a game console (e.g., Xbox™ or PlayStation™), an electronic dictionary, an electronic key, a camcorder, or an electronic picture frame

In other various embodiments of the present disclosure, an electronic device may include at least one of various medical devices (e.g., various portable medical measurement devices (e.g., a blood glucose measuring device, a heart rate measuring device, a blood pressure measuring device, a body temperature measuring device, or the like), a magnetic resonance angiography (MRA), a magnetic resonance imaging (MRI), a computed tomography (CT), a scanner, an ultrasonic device, or the like), a navigation device, a global navigation satellite system (GNSS), an event data recorder (EDR), a flight data recorder (FDR), a vehicle infotainment device, electronic equipment for vessels (e.g., a navigation system, a gyrocompass, or the like), avionics, a security device, a head unit for a vehicle, an industrial or home robot, an automatic teller machine (ATM), a point of sales (POS) device of a store, or an Internet of things (IoT) device (e.g., a light bulb, various sensors, an electric or gas meter, a sprinkler, a fire alarm, a thermostat, a streetlamp, a toaster, exercise equipment, a hot water tank, a heater, a boiler, or the like).

According to various embodiments of the present disclosure, an electronic device may include at least one of a part of furniture or a building/structure, an electronic board, an electronic signature receiving device, a projector, or a measuring instrument (e.g., a water meter, an electricity meter, a gas meter, a wave meter, or the like). An electronic device may be one or more combinations of the above-mentioned devices. An electronic device according to some various embodiments of the present disclosure may be a flexible device. An electronic device according to an embodiment of the present disclosure is not limited to the above-mentioned devices, and may include new electronic devices with the development of new technology.

Hereinafter, an electronic device according to various embodiments of the present disclosure will be described in more detail with reference to the accompanying drawings. The term “user” used herein may refer to a person who uses an electronic device or may refer to a device (e.g., an artificial intelligence electronic device) that uses an electronic device.

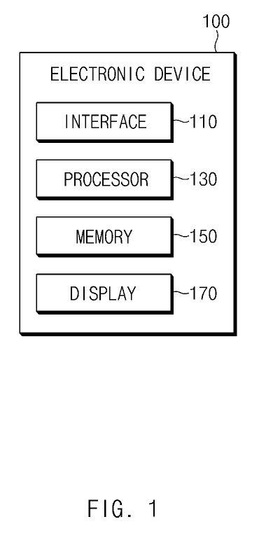

FIG. 1 is a block diagram of an electronic device related to control of a screen according to an embodiment.

The electronic device 100 may be connected to a plurality of external devices through an interface 110, and may output a screen corresponding to source inputs received from the external devices through a display 170. Further, when any one external device is switched to another external device, the electronic device 100 may provide a screen related to the switching to the external device while the source inputs are switched. Accordingly, the electronic device 100 may prevent a screen cut-off phenomenon that may be generated in a time gap during which the source inputs are switched.

Referring to FIG. 1, the electronic device 100 for performing the above-mentioned function may include an interface 110, a processor 130, a memory 150, and a display 170. However, the configuration of the electronic device 100 is not limited thereto. According to various embodiments, at least one of the elements of the electronic device 100 may be excluded or at least one other element may be further included.

The interface 110 may deliver commands or data input from the user or another external device to another element(s) of the electronic device 100, or may output commands or data received from another element(s) of the electronic device 100 to the user or another external device. The interface 110, for example, may include a high-definition multimedia interface (HDMI), a universal serial bus (USB), an optical interface, or a D-subminiature (D-sub). Additionally or alternatively, the interface 110 may include a mobile high-definition link (MHL) interface, a secure digital (SD) card/multimedia card (MMC) interface, or an infrared data association (IrDA) standard interface.

According to an embodiment, the electronic device 100 may further include a plurality of interfaces 110. Accordingly, the electronic device 100 may be connected to a plurality of external devices through interfaces 110, respectively.

The processor 130 may execute operations or data processing related to the control and/or communication of at least one other element of the electronic device 100. The processor 130, for example, may control a plurality of hardware or software components connected by driving an operating system or an application program and perform a variety of data processing or calculations. The processor 130 may include one or more of a central processing unit (CPU), an application processor (AP), or a communication processor (CP). According to an embodiment, the processor 130 may be implemented by a System on Chip (SoC).

According to an embodiment, the processor 130 may constitute a screen corresponding to a source input received from an external device connected through the interface 110 and may output the screen on the display 170. As an example, the processor 130 may receive a source input from a set-top box that supports an internet protocol television (IPTV) if the set-top box is connected through the interface 110, and may constitute a screen of a broadcasting channel corresponding to the source input to output the screen of the broadcasting channel on the display 170. As another example, the processor 130 may receive a source input from a game console if the game console is connected through the interface 110, and constitute a game screen corresponding to the source input to output the game screen on the display 170.

According to an embodiment, if a request for switching between the interfaces 110 is made, the processor 130 may constitute a screen related to switching of the interfaces 110 (or switching of the external devices connected to the interfaces 110) while the source inputs received through the interfaces 110 to output the screen on the display 170. For example, the processor 130 may output a first screen corresponding to a first source input received from a first external device through a first interface, and if a request for switching to a second interface, may output a third screen related to switching to the second interface until a second source input is received from a second external device connected through the second interface (until a second screen corresponding to the second source input is output). Accordingly, a screen cut-off phenomenon (e.g., a phenomenon of outputting a black screen or the like) that may occur during switching between the interfaces 100 may be prevented.

The third screen related to switching on the interfaces 110 may include information on the interfaces 110 or information on the external devices connected to the interfaces 110. The information on the interfaces 110, for example, may include the types of ports or the names of the ports. Further, the information on the external devices, for example, may include the types of the external devices, the brand names of the external devices, or the product images of the external devices.

According to an embodiment, the processor 130 may output the third screen from a first time point at which the first screen is terminated until shortly before a second time point at which the second screen is output. As another example, the processor 130 may maintain the output of the third screen until shortly before a third time point to which a specific time interval passes from the second time point. For example, the processor 130 may further provide an overlapping time period during switching of the screens.

According to an embodiment, the processor 130 may output the third screen on the second screen from the second time point, and may gradually increase a transparency of the third screen until shortly before the third time point. For example, the processor 130 may apply an effect of fading out the third screen.

According to an embodiment, when the first interface is switched to the second interface, the processor 130 may provide information related to recognition of the second external device on the third screen while recognizing the second external device if the second external device connected through the second interface is not recognized (or detected). The information related to recognition of the second external device, for example, may include notification information indicating that the second external device is being recognized.

According to an embodiment, when the second external device is not recognized, the processor 130 may output a fourth screen including notification information indicating that recognition of the second external device is impossible, on the display 170. The fourth screen may include a text or an image indicating that the recognition of the second external device is impossible, and may further include an object, such as a button, that helps set the second interface.

According to an embodiment, when the intensity of the second source input received from the second external device is weak (e.g., when the intensity of the input signal is a specific value or less) or the second source input includes information corresponding to a scrambled channel, the processor 130 may output a fifth screen including notification information indicating a state of the source input on the display 170 before the third screen is output.

According to an embodiment, when there is no second source input received from the second external device in a state in which the second external device is recognized (or connected), the processor 130 may output a sixth screen including notification information indicating that there is not source input, on the display 170. The sixth screen may include a text or an image indicating that there is no source input, and may further include an object, such as a button, that helps set the second external device.

According to an embodiment, when the second source input does not include video information, the processor 130 may output a seventh screen including notification information indicating that there is no video information, on the display 170. The seventh screen may include a text or an image indicating that there is no video information, and may further include an object, such as a button, that helps set the second external device or switch the current interface to another interface. In some embodiments, when the second source input does not include video information, the processor 130 may provide specific information stored in the memory 150 to the third screen. The specific information, for example, may include a text or an image indicating that there is no video information.

According to an embodiment, when a plurality of external devices are connected through a plurality of interfaces 110, the processor 130 may output an eighth screen that helps selecting one of the plurality of external devices, on the display 170. As another example, if only any one of the plurality of external devices is recognizable, the processor 130 terminates output of the eighth screen, and may output a screen corresponding to a source input received from the recognizable external device on the display 170.

The memory 150 may include a volatile and/or nonvolatile memory. The memory 150, for example, may store a command or data related to at least one other component of the electronic device 100. According to an embodiment, the memory 150 may store software and/or a program. The program may include an application. The application may be a set of programs (or instructions) for performing at least one specific function.

According to an embodiment, the memory 150 may store information for constituting the third screen that is output when the interfaces 110 are switched. For example, the memory 150 may store a text or an image that is necessary for constituting a screen.

The display 170 may display various contents (for example, a text, an image, an audio, a video, an icon, and/or a symbol) to the user. According to an embodiment, the display 170 may output a screen corresponding to a source input received from an external device connected through the interface 110. According to an embodiment of the present disclosure, the display 170 may include a liquid crystal display (LCD), a light emitting diode (LED) display, an organic light emitting diode (OLED) display, a micro electromechanical system (MEMS) display, and an electronic paper display. According to an embodiment, the display 170 may include a touch screen and receive, for example, a touch, a gesture, a proximity, or a hovering input using an electronic pen or the user's body.

As described above, according to various embodiments, an electronic device (e.g., the electronic device 100) may include a first interface (e.g., the interface 110) for connection to a first external device, a second interface (e.g., the interface 110) for connection to a second external device, a display (e.g., the display 170) configured to output a screen, a memory (e.g., the memory 150) configured to store information for constituting the screen, and a processor (e.g., the processor 130) electrically connected to the first interface, the second interface, the display, and the memory. The memory may store instructions that, when executed, cause the processor to receive a first source input from the first external device through the first interface, output a first screen corresponding to the first source input on the display, if a request for switching from the first interface to the second interface is received, output a second screen related to switching to the second external device on the display, and if a first time point at which a second source input is received from the second external device through the second interface comes, output a third screen corresponding to the second source input on the display.

According to various embodiments, the memory may store instructions that, when executed, cause the processor to output the second screen on the third screen until shortly before a second time point to which a specific time interval passes from the first time point, and if the second time point comes, terminate output of the second screen.

According to various embodiments, the memory may store instructions that, when executed, cause the processor to gradually increase a transparency of the second screen output on the third screen from the first time point until shortly before the second time point.

According to various embodiments, the memory may store instructions that, when executed, cause the processor to provide at least one of information on the second interface and information on the second external device on the second screen.

According to various embodiments, the memory may store instructions that, when executed, cause the processor to provide information related to recognition of the second external device on the second screen while transmitting a signal for recognizing the second external device to the second external device in a state in which the second external device is not recognized before the request for switching is received.

According to various embodiments, the memory may store instructions that, when executed, cause the processor to provide specific information stored in the memory to the third screen when the second source input does not include video information.

According to various embodiments, the memory may store instructions that, when executed, cause the processor to provide notification information indicating that the second source input does not include video information on the second screen.

According to various embodiments, the memory may store instructions that, when executed, cause the processor to receive the request for switching if an input of a user related to switching to the second interface is made or the second external device is connected to the second interface.

According to various embodiments, an electronic device may include a first interface for connection to a first external device, a second interface for connection to a second external device, a third interface for connection to a third external device, a display configured to output a screen, a memory configured to store information for constituting the screen, and a processor electrically connected to the first interface, the second interface, the third interface, the display, and the memory. The memory may store instructions that, when executed, cause the processor to receive a first source input from the first external device through the first interface, output a first screen corresponding to the first source input on the display, if a request for switching from the first interface to another interface that is different from the first interface is received, output a second screen to select one external device of the second external device or the third external device on the display, if a user input for selecting one external device of the second external device or the third external device is received, output a third screen related to switching to the selected one external device on the display, and if a second source input is received from the selected one external device through an interface for connection to the one selected external device, output a fourth screen corresponding to the second source input on the display.

According to various embodiments, the memory may store instructions that, when executed, cause the processor to provide information related to recognition of the at least one external device to the second screen while transmitting a signal for recognizing the at least one external device that has not be recognized to the at least one external device in a state in which at least one external device of the second external device and the third external device is not recognized before the request for switching is received.

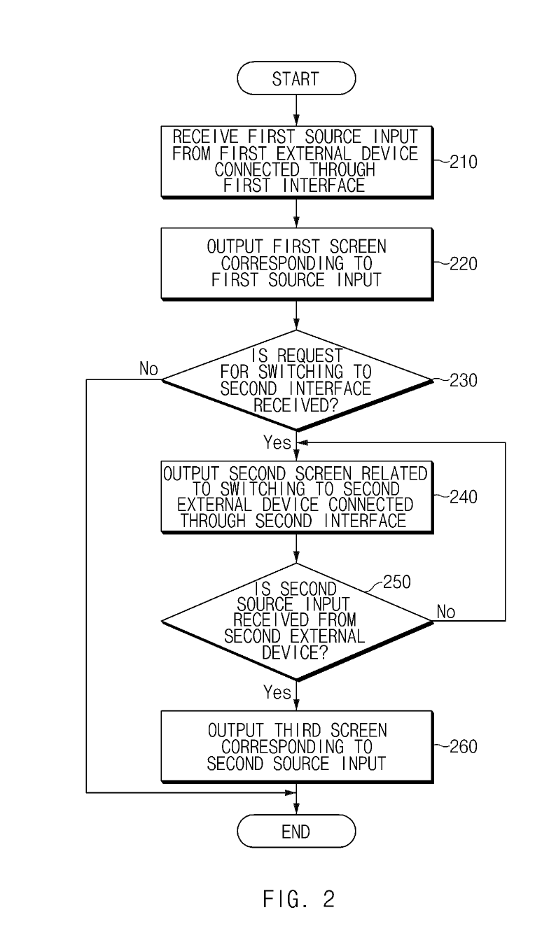

FIG. 2 is a view illustrating a method for managing an electronic device related to control of a screen according to an embodiment.

Referring to FIG. 2, in operation 210, an electronic device (e.g., the electronic device 100) may receive a first source input from a first external device connected through a first interface (e.g., the interface 110). As an example, the electronic device may receive a broadcasting signal from a set-top box connected to the first interface or may receive a data signal of a game application from a game console connected to the first interface.

In operation 220, the electronic device may output a first screen corresponding to the first source input on a display (e.g., the display 170). As an example, the electronic device may output a screen of a broadcasting channel corresponding to the broadcasting signal on the display, or may output a game screen corresponding to to data signal of the game application on the display.

In operation 230, the electronic device may determine whether a request for switching to a second interface (e.g., the interface 110) is received. According to an embodiment, if a user input (e.g., a button input related to switching of interfaces) related to switching between the interfaces or the second external device is connected to the second interface in a state in which the first external device is connected to the first interface, the electronic device may receive a request for switching of the interfaces. Similarly to the first external device, the second external device may be a smartphone, a set-top box, or a game console.

If a request for switching to the second interface is received, in operation 240, the electronic device may output a second screen related to switching to the second external device connected through the second interface. According to an embodiment, the electronic device may output the second screen from a first time point at which the first screen is terminated until shortly before a second time point at which the second source input is received from the second external device. In some embodiments, the electronic device may maintain the output of the second screen until shortly before a third time point to which a specific time interval passes from the second time point.

According to an embodiment, during switching to the second interface, the electronic device may provide information related to recognition of the second external device on the second screen while recognizing the second external device if the second external device connected through the second interface is not recognized. For example, the electronic device may provide notification information indicating that the second external device is being recognized, to the second screen.

In operation 250, the electronic device may determine whether the second source input has been received from the second external device through the second interface. When the second source input is not received, the process may return to operation 240. For example, the electronic device may maintain the output of the second screen until shortly before the second source input is received.

If the second source input is received, in operation 260, the electronic device may output a third screen corresponding to the second source input on the display. According to various embodiments, the electronic device may output the third screen from the second time point at which the second source input is received, and may output the second screen on the third screen. Further, the electronic device may gradually increase the transparency of the second screen until shortly before a third time point to which a specific time interval passes from the second time point to fade out the second screen.

As described above, according to various embodiments, a method of controlling a screen of an electronic device may include receiving a first source input from a first external device through a first interface, outputting a first screen corresponding to the first source input on a display, receiving a request for switching to another interface that is different from the first interface, outputting a second screen including a first object for selecting a second external device connected through a second interface and a second object for selecting any one external device of a plurality of third external devices connected through a plurality of third interfaces, respectively, on the display, receiving a first user input for selecting the first object or the second object, if the first user input is an input for selecting the first object, outputting a third screen related to switching to the second external device, and if a first time point at which a second source input is received from the second external device comes, outputting a fourth screen corresponding to the second source input, and if the first user input is an input for selecting the second object, outputting a fifth screen for selecting any one external device of the plurality of third external devices, if a second user input for selecting any one external device of the plurality of third external devices is received, outputting a sixth screen related to switching to one external device selected from the plurality of third external devices, and if a second time point at which a third source input is received from the selected one external device, outputting a seventh screen corresponding to the third source input.

According to various embodiments, the outputting of the fourth screen may include outputting the third screen on the fourth screen until shortly before a third time point to which a specific time interval passes from the first time point, and if the third time point comes, terminating the output of the third screen.

According to various embodiments, the outputting of the third screen on the fourth screen may include gradually increasing a transparency of the third screen output on the fourth screen from the first time point until shortly before the third time point.

According to various embodiments, the outputting of the seventh screen may include outputting the sixth screen on the seventh screen until shortly before a fourth time point to which a specific time interval passes from the second time point, and if the fourth time point comes, terminating the output of the sixth screen.

According to various embodiments, the outputting of the sixth screen on the seventh screen may include gradually increasing a transparency of the sixth screen output on the seventh screen from the second time point until shortly before the fourth time point.

According to various embodiments, the first object may include at least one of information on the second interface and information on the second external device.

According to various embodiments, in a state in which the second external device is not recognized before a request for switching is received, the method may further include recognizing the second external device, and providing information related to the recognition of the second external device to the second screen.

According to various embodiments, the fifth screen may include at least one of information on the plurality of third interfaces and information on plurality of third external devices.

According to various embodiments, in a state in which at least one external device of the plurality of third external devices is not recognized before the fifth screen is output, the method may further include recognizing the at least one external device that has not be recognized, and providing information related to the recognition of the at least one external device to the fifth screen.

According to various embodiments, the receiving of the request of switching may include receiving the request for switching if a user input related to switching to the another interface is made or another external device different from the first external device is connected to the another interface.

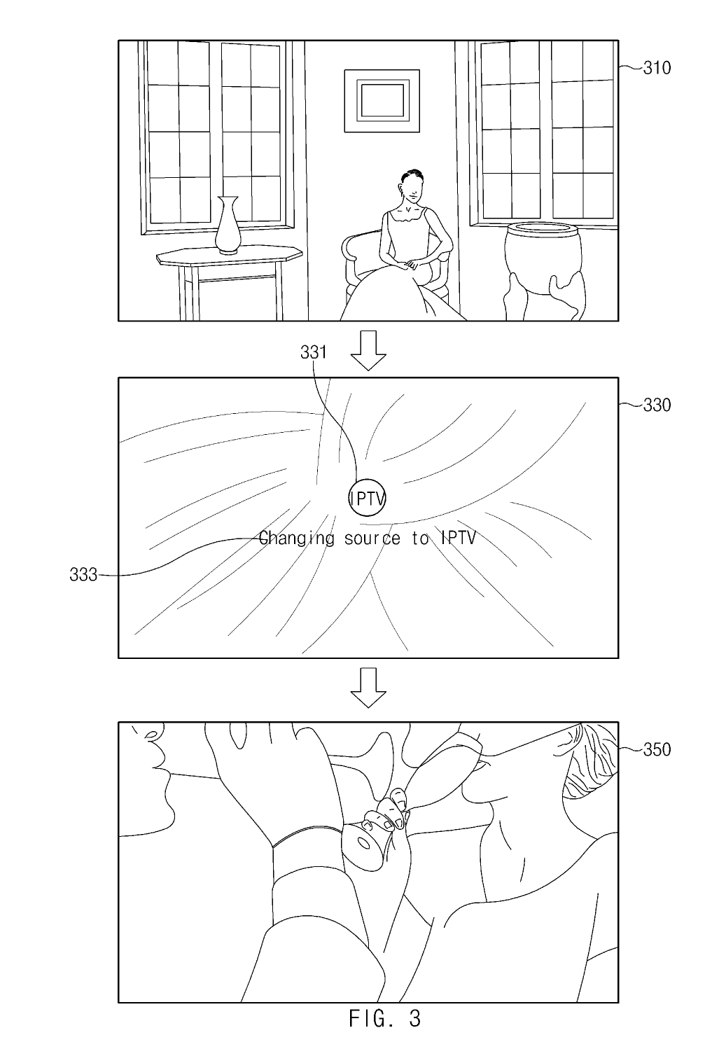

FIG. 3 is an exemplary view of a screen related to control of a screen according to an embodiment.

Referring to FIG. 3, an electronic device (e.g., the electronic device 100) may output a first screen 310 corresponding to a first source input received from a first external device (e.g., a smartphone) connected through a first interface on a display (e.g., the display 170). Thereafter, if receiving a request for switching from the first interface to a second interface, the electronic device may output a second screen 330 related to switching to the second interface on the display.

The second screen 330, for example, may include information on the second interface or information on a second external device (e.g., a set-top box) connected though the second interface. In the illustrated drawing, the second screen 330 displays a state including a text indicating the type 331 (e.g., a set-top box supporting an IPTV) of the second external device and that switching to the second external device is being made. In some embodiments, the second screen 330 may include a brand name of the second external device or a product image of the second external device.

If receiving a second source input from the second external device through the second interface, the electronic device may output a third screen 350 corresponding to the second source input on the display. According to various embodiments, the electronic device may output the third screen 350 from a time point at which the second source input is received, may output the second screen 330 on the third screen 350, and may gradually increase the transparency of the second screen 330 until a time point to which a specific time interval passes to fade out the second screen 330. A screen may be switched more smoothly by fading out the second screen 330.

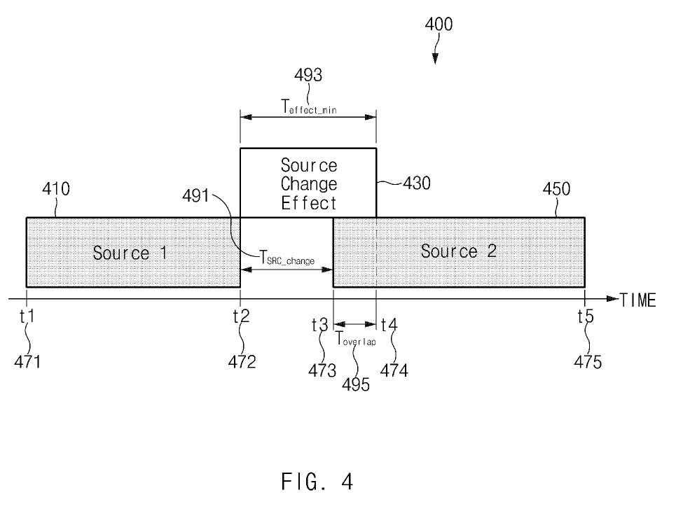

FIG. 4 is a view for explaining switching of source inputs according to an embodiment.

Referring to FIG. 4, as in a graph 400, an electronic device (e.g., the electronic device 100) may output a first screen corresponding to a first source input 410 on a display (e.g., the display 170) from a first time point (t1) 471 at which a first source input 410 is received through a first interface until shortly before a second time point (t2) 472 at which a request for switching to a second interface is received.

The electronic device may output a second screen including information 430 related to switching to the second interface on the display from the second time point 472. A time interval (Teffect_min) 493 at which the second screen is output may range from the second time point 472 to a third time point (t3) 473 at which a second source input 450 is received from a second external device connected through the second interface. That is, the time interval 493 during which the second screen is output may correspond to a time range (Tsrc_change) 491 in which the first source input 410 is switched to the second source input 450.

According to various embodiments, the electronic device may maintain output of the second screen until a fourth time point (t4) 474 to which a specific time interval (Toverlap) 495 passes from the third time point 473 at which the second source input 450 is received, instead of terminating the output of the second screen at the third time point 473. The specific time interval 495 is a time interval that is set to perform switching of screens more smoothly, and the electronic device may constitute the second screen corresponding to the received second source input 450 during the specific time interval 495. For example, even though the second source input is received from the second external device, the second screen may not be constituted immediately at the received time point (e.g., the third time point 473). Accordingly, the electronic device may set an overlap zone in which the second screen may be constituted during the specific time interval 495.

According to various embodiments, the electronic device may output the second screen on a third screen corresponding to the second source input 450 while outputting the third screen on the second screen during the specific time interval 495. For example, the electronic device may output the second screen such that the second screen covers the third screen. Further, the electronic device may apply a fade-out effect such that the third screen appears while the second screen gradually disappears by gradually increasing the transparency of the second screen. The time interval during which the transparency of the second screen is applied may range from the third time point 473 to a fourth time point 474. Further, the time interval during which the transparency of the second screen is applied may range from the second time point 472 to a fourth time point 474.

Thereafter, the electronic device may output the third screen on the display until a fifth time point (t5) 475 at which the reception of the second source input 450 is terminated.

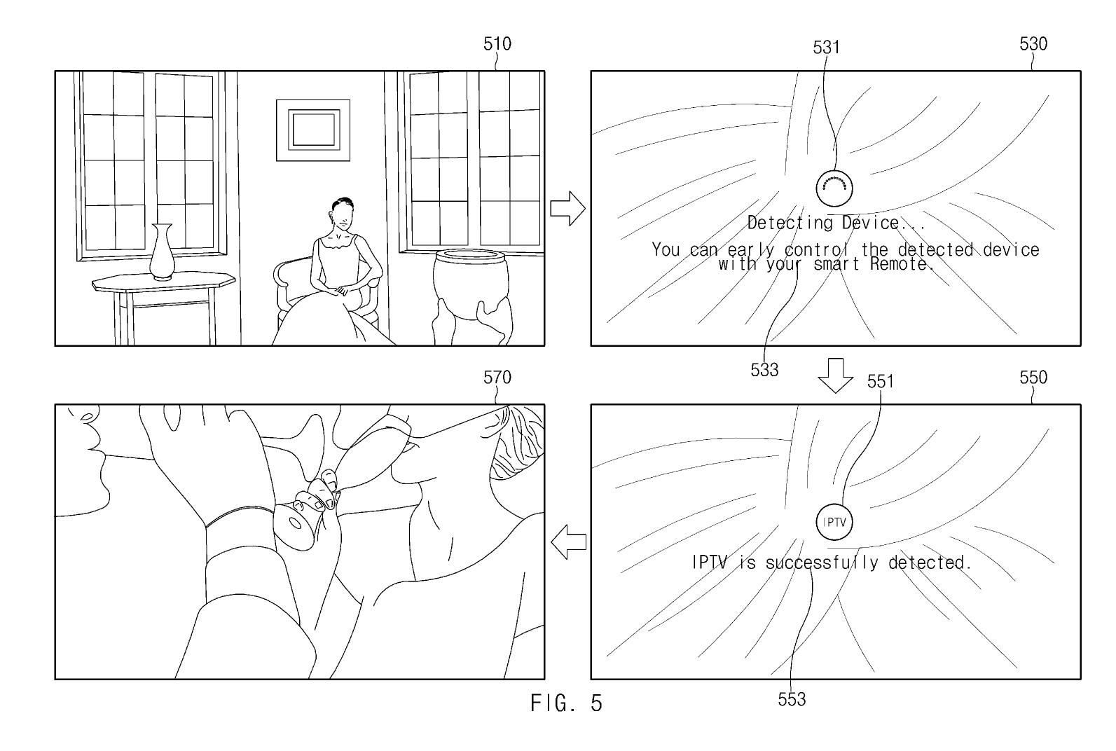

FIG. 5 is a view illustrating a screen related to switching to an external device according to an embodiment.

Referring to FIG. 5, when a first interface is switched to a second interface, an electronic device (e.g., the electronic device 100) may provide information related to recognition of the second external device on a screen related to switching to the second interface while recognizing the second external device if the second external device connected through the second interface is not recognized.

As in the illustrated drawing, the electronic device may output a first screen 510 corresponding to a first source input received from a first external device connected through the first interface on a display (e.g., the display 170). Thereafter, if receiving a request for switching from the first interface to a second interface, the electronic device may output a second screen 550 related to switching to the second interface on the display. The second screen 550, for example, may include information on the second interface or information on a second external device connected though the second interface. The information on the second external device, for example, may include the type 551 of the second external device or a text 553 informing that the second external device is connected. In some embodiments, the second screen 550 may include a brand name of the second external device or a product image of the second external device.

In a state in which the second external device connected to the second interface is not recognized, the electronic device may provide information related to recognition of the second external device on the second screen 550. The information related to recognition of the second external device, for example, may include notification information indicating that the second external device is being recognized. According to an embodiment, the notification information may include an image 531 or a text 533 indicating that the second external device is being recognized.

According to an embodiment, the electronic device may output a third screen 530 including information (e.g., an image 531 or a text 533) indicating that the second external device is being recognized on the display before the second screen 550 is output. For example, the electronic device may output the third screen 530 on the display from a time point at which a request for switching to the second interface until a time point at which the second external device is successfully recognized, and may output the second screen 550 from a time at which the second external device is successfully recognized until a time point at which a second source input is received from the second external device. Thereafter, the electronic device may output a fourth screen 570 corresponding to the second source input received from the second external device on the display.

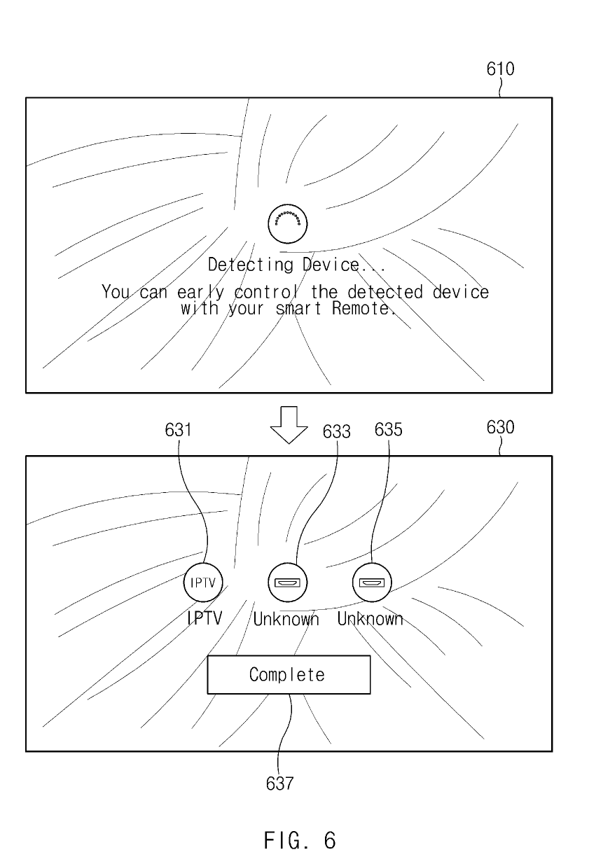

FIG. 6 is a view for explaining a state in which a plurality of external devices are connected according to an embodiment.

Referring to FIG. 6, when a plurality of external devices are connected through a plurality of interfaces, an electronic device (e.g., the electronic device 100) may output a screen 630 that helps select one of the plurality of external devices on a display (e.g., the display 170). For example, if receiving a request for switching to at least one second interface that is different from a first interface in a state in which a first screen corresponding to a first source input received from a first external device through the first interface, the electronic device may output a first screen 610 related to switching of interfaces on the display while detecting (or recognizing) the external devices connected through the plurality of interfaces included in the electronic device. The first screen 610, for example, may include an image or a text indicating that an external device is being detected.

When a plurality of external devices connected to the plurality of interfaces exist, the electronic device may output a second screen 630 that helps select any one of the plurality of external devices on the display. The second screen 630, for example, may include information (e.g., the type of the first external device, the type of the second external device, or the type of the third external device) on the plurality of external devices or an object 637, such that a button, which function to switch to the selected external device. According to an embodiment, the information on the plurality of external devices may be mapped with an object, such as a button, that may be selected by the user to be output. For example, if the user selects the object 637 after selecting a first button 631 with which an image indicating the type of the first external device is mapped, a second button 633 with which an image indicating the type of the second external device is mapped, and a third button 635 with which an image indicating the type of the third external device is mapped, the electronic device may output a screen corresponding to a source input received from the external device corresponding to the selected button on the display. Further, if the user selects the first button 631, the second button 633, or the third button 635, the electronic device may output a screen corresponding to a source input received from the external device corresponding to the selected button on the display.

According to an embodiment, if only any one of the plurality of external devices is recognizable, the electronic device may output a screen corresponding to the source input received from the recognizable external device on the display. For example, the electronic device may automatically perform switching to the recognizable external device.

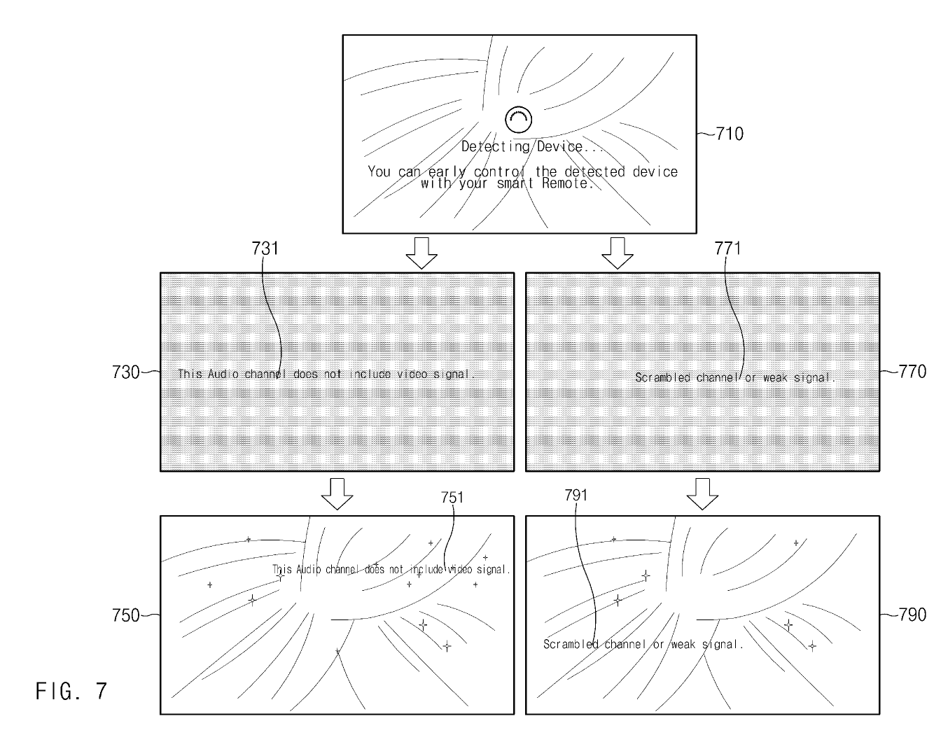

FIG. 7 is a view for explaining a screen that is provided according to a state of a source input according to an embodiment.

Referring to FIG. 7, when a first interface is switched to a second interface, an electronic device (e.g., the electronic device 100) may differently output a screen related to switching to the second interface according to a state of a source input received from an external device connected through the second interface.

According to an embodiment, when recognition of the external device connected through a second interface is completed and the source input received from the external device does not include video information in a state in which a first screen 710 related to the recognition of the external device is output on a display (e.g., the display 170), the electronic device may output a second screen including notification information 731 indicating that the output of the first screen is completed and there is no video information, on the display. Further, the electronic device may output a third screen 750 including notification information 751 indicating that there is no video information on the display while outputting other information (e.g., audio information) included in the source input through an output device (e.g., a speaker) that may output the other information. Then, the notification information 751 included in the third screen 750 may be animated such that a location of display and the like may be changed. In some embodiments, the third screen 750 may include specific information (e.g., a wave image corresponding to a sound wave) stored in a memory (e.g., the memory 150).

According to an embodiment, when the intensity of a signal of a source input received from the external device is weak (e.g., when the intensity of an input signal is a specific value or less) or the source input includes information corresponding to a scrambled channel, the electronic device may output a fourth screen 770 including notification information 771 indicating that the output of the first screen 710 is completed and the intensity of the received signal is weak or the source input corresponds to a scrambled channel. Further, if a fifth screen 790 corresponding to the source input is output on the display, the electronic device may provide notification information 791 indicating that the intensity of the received signal is weak or the source input corresponds to a scrambled channel. Then, the notification information 790 included in the fifth screen 791 may be animated such that a location of display and the like may be changed. In some embodiments, the fifth screen 790 may include specific information (e.g., an image designated according to a state of the source input) stored in the memory.

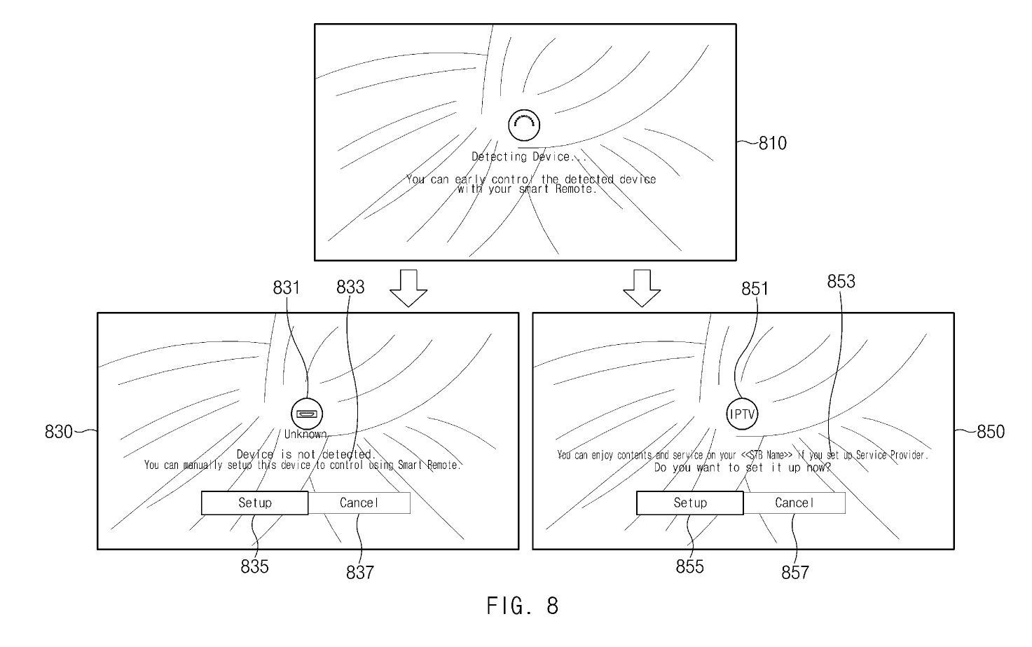

FIG. 8 is a view for explaining a state in which a setting screen for an external device is provided according to an embodiment.

Referring to FIG. 8, when a first interface is switched to a second interface, an electronic device (e.g., the electronic device 100) may output a screen 830 related to setting of the external device when an external device connected through the second interface is not recognized. For example, if recognition of the external device fails in a state in which the first screen 810 related to the recognition of the external device connected through the second interface is output on the display, the second screen 830 related to the setting of the external device may be output on the display. The second screen 830, for example, may include information 831 on the second interface, notification information 833 indicating that the external device has not been recognized, a setting button 835 that helps set the external device, or a cancel button 837 that functions to cancel connection to the external device.

According to an embodiment, when the first interface is switched to the second interface, the electronic device may output a screen that helps set an external device connected through the second interface on the display. For example, if recognition of the external device is completed in a state in which the first screen 810 related to the recognition of the external device connected through the second interface is output on the display, the third screen 850 related to the setting of the external device may be output on the display. The third screen 850, for example, may include information 851 on the external device, notification information 853 indicating that setting related to a service provider that provides a service through the external device may be changed, a setting button 855 that helps change setting related to the service provider, or a cancel button 857 that functions to cancel change of the setting.

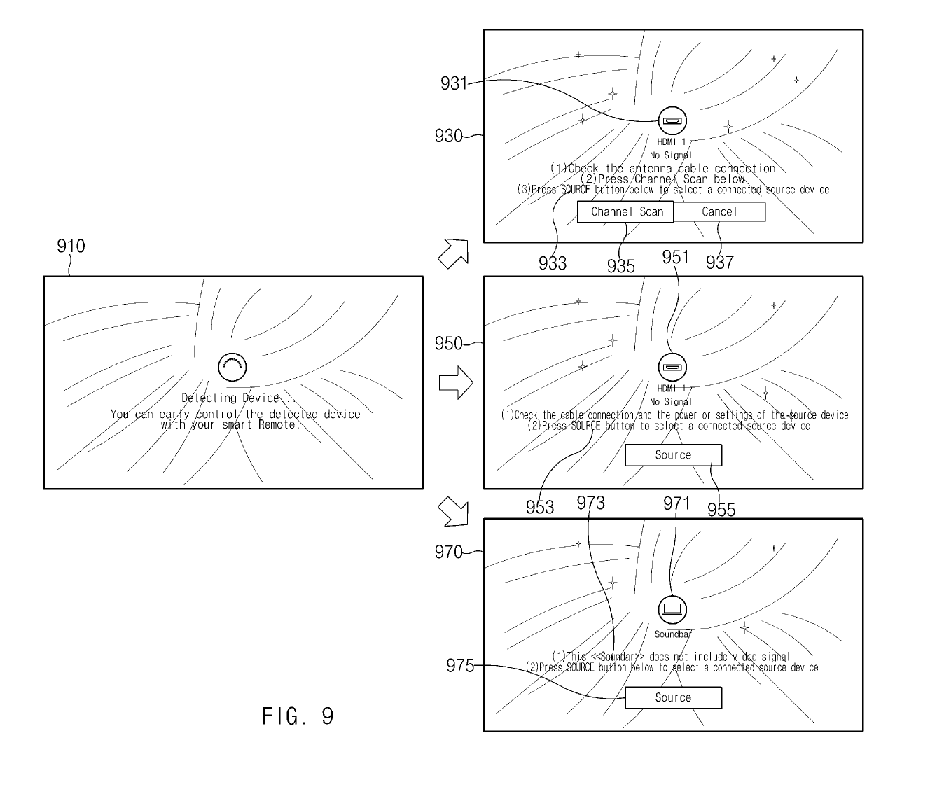

FIG. 9 is a view for explaining another screen that is provided according to a state of a source input according to an embodiment.

Referring to FIG. 9, when a first interface is switched to a second interface, an electronic device (e.g., the electronic device 100) may differently output a screen related to switching to the second interface according to a state of a source input received from an external device connected through the second interface.

According to an embodiment, when recognition of the external device connected through a second interface is completed and there is no source input received from the external device in a state in which a first screen 910 related to the recognition of the external device is output on a display (e.g., the display 170), the electronic device may output a second screen informing that the output of the first screen 910 is completed and there is no source input, on the display.

The second screen 930, for example, may include information 931 (or information on the external device) on the second interface, information 933 indicating that there is no source input, a scan button 935 that helps identify a connection state to the external device or receive the source input again, or a cancel button 937 that functions to cancel switching to the external device. If the scan button 935 is selected, for example, when the external device is a set-top box that supports an IPTV, the electronic device may help scan the channel of the IPTV.

According to an embodiment, when recognition of the external device connected through a second interface is completed and there is no source input received from the external device in a state in which a first screen 910 related to the recognition of the external device is output on a display, the electronic device may output a third screen 930 informing that the output of the first screen 910 is completed and there is no source input, on the display.

The third screen 930, for example, may include information 951 (or information on the external device) on the second interface, information 953 indicating that there is no source input, or a button 955 that helps switch to another interface other than the second interface.

According to an embodiment, when recognition of the external device connected through a second interface is completed and a source input received from the external device does not include video information in a state in which a first screen 910 related to the recognition of the external device is output on a display, the electronic device may output a fourth screen 970 informing that the output of the first screen 910 is completed and the source input does not include video information, on the display.

The fourth screen 970, for example, may include information 971 on the external device, notification information 973 indicating that the source input does not include video information, or a button 975 that helps switch to another interface other than the second interface.

The term “module” used herein may represent, for example, a unit including one of hardware, software and firmware or a combination thereof. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions thereof) or methods (e.g., operations) according to various embodiments of the present disclosure may be implemented as instructions stored in a computer-readable storage medium in the form of a program module. In the case where the instructions are performed by a processor, the processor may perform functions corresponding to the instructions.

A computer-readable recording medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The program instructions may include machine language codes generated by compilers and high-level language codes that can be executed by computers using interpreters. The above-mentioned hardware device may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module or other elements according to various embodiments of the present disclosure may be performed in a sequential, parallel, iterative or heuristic way. Furthermore, some operations may be performed in another order or may be omitted, or other operations may be added.

While the present disclosure has been shown and described with reference to certain embodiments thereof, it will be understood by those skilled in the art that various changes in form and details may be made therein without departing from the scope of the present disclosure. Therefore, the scope of the present disclosure should not be defined as being limited to the embodiments, but should be defined by the appended claims and equivalents thereof.

What is claimed is:

1. An electronic device comprising:
a first interface connectable to a first external device;
a second interface connectable to a second external device;
a display configured to output a screen;
a memory configured to store instructions; and
a processor connected to the first interface, the second interface, the display, and the memory,
wherein the instructions, when executed by the processor, cause the processor to:
receive a first source input from the first external device through the first interface;
output, on the display, a first screen corresponding to the first source input;
in response to receiving a request for switching from the first interface to the second interface, output, on the display, a second screen related to switching to the second external device; and
when a second source input is received, at a first time point, from the second external device through the second interface, output, on the display, a third screen corresponding to the second source input.

2. The electronic device of claim 1, wherein the instructions, when executed by the processor, further cause the processor to:
output the second screen on the third screen until before a second time point so that a specific time interval passes from the first time point; and
in response to the specific time interval passing, terminate output of the second screen.

3. The electronic device of claim 2, wherein the instructions, when executed by the processor, further cause the processor to:
gradually increase a transparency of the second screen output on the third screen from the first time point until before the second time point.

4. The electronic device of claim 1, wherein the instructions, when executed by the processor, further cause the processor to:
provide at least one of information on the second interface and information on the second external device on the second screen.

5. The electronic device of claim 1, wherein the instructions, when executed by the processor, further cause the processor to:
in a state in which the second external device is not recognized before receiving the request for switching, provide information related to recognition of the second external device on the second screen while transmitting a signal for recognizing the second external device to the second external device.

6. The electronic device of claim 1, wherein the instructions, when executed by the processor, further cause the processor to:
when the second source input does not include video information, provide specific information stored in the memory to the third screen.

7. The electronic device of claim 6, wherein the instructions, when executed by the processor, further cause the processor to:
provide notification information indicating that the second source input does not include video information on the second screen.

8. The electronic device of claim 1, wherein the instructions, when executed by the processor, further cause the processor to:
in response to an input of a user related to switching to the second interface is made or the second external device is connected to the second interface, receive the request for switching.

9. An electronic device comprising:
a first interface connectable to a first external device;
a second interface connectable to a second external device;
a third interface connectable to a third external device;
a display configured to output a screen;
a memory configured to store instructions; and
a processor connected to the first interface, the second interface, the third interface, the display, and the memory,
wherein the instructions, when executed by the processor, cause the processor to:
receive a first source input from the first external device through the first interface;
output, on the display, a first screen corresponding to the first source input;
in response to receiving a request for switching from the first interface to another interface that is different from the first interface, output, on the display, a second screen to select one external device of the second external device or the third external device;
in response to receiving a user input for selecting the one external device of the second external device or the third external device, output, on the display, a third screen related to switching to the selected one external device; and
when a second source input is received from the selected one external device through an interface for connection to the one selected external device, output, on the display, a fourth screen corresponding to the second source input.

10. The electronic device of claim 9, wherein the instructions, when executed the processor, further cause the processor to:
in a state in which at least one external device of the second external device and the third external device is not recognized before receiving the request for switching, provide information related to recognition of the at least one external device to the second screen while transmitting a signal for recognizing the at least one external device that has not be recognized to the at least one external device.

11. A method of controlling a screen of an electronic device, the method comprising:
receiving a first source input from a first external device through a first interface;
outputting, on a display, a first screen corresponding to the first source input;
receiving a request for switching to another interface that is different from the first interface;
outputting, on a display a second screen including a first object for selecting a second external device connected through a second interface and a second object for selecting any one external device of a plurality of third external devices connected through a plurality of third interfaces, respectively;
receiving a first user input for selecting the first object or the second object;
in response to receiving the first user input for selecting the first object,
outputting a third screen related to switching to the second external device, and
when a second source input is received, at a first time point, from the second external device, outputting a fourth screen corresponding to the second source input; and
in response to receiving the first user input for selecting the second object,
outputting a fifth screen for selecting any one external device of the plurality of third external devices,
receiving a second user input for selecting any one external device of the plurality of third external devices,
in response to receiving the second user input, outputting a sixth screen related to switching to the one external device selected from the plurality of third external devices, and
when a third source input is received, at a second time point, from the selected one external device, outputting a seventh screen corresponding to the third source input.

12. The method of claim 11, wherein the outputting of the fourth screen includes:
outputting the third screen on the fourth screen until before a third time point so that a specific time interval passes from the first time point; and
in response to the specific time interval passing, terminating the output of the third screen.

13. The method of claim 12, wherein the outputting of the third screen on the fourth screen includes:
gradually increasing a transparency of the third screen output on the fourth screen from the first time point until before the third time point.

14. The method of claim 11, wherein the outputting of the seventh screen includes:
outputting the sixth screen on the seventh screen until before a fourth time point so that a specific time interval passes from the second time point; and
in response to the specific time interval passing, terminating the output of the sixth screen.

15. The method of claim 14, wherein the outputting of the sixth screen on the seventh screen includes:
gradually increasing a transparency of the sixth screen output on the seventh screen from the second time point until before the fourth time point.

16. The method of claim 11, wherein the first object includes at least one of information on the second interface and information on the second external device.

17. The method of claim 11, wherein in a state in which the second external device is not recognized before receiving the request for switching, the method further comprises:
recognizing the second external device; and
providing information related to the recognition of the second external device to the second screen.

18. The method of claim 11, wherein the fifth screen includes at least one of information on the plurality of third interfaces and information on plurality of third external devices.

19. The method of claim 11, wherein, in a state in which at least one external device of the plurality of third external devices is not recognized before the fifth screen is output, the method further comprises:
recognizing the at least one external device that has not be recognized; and
providing information related to the recognition of the at least one external device to the fifth screen.

20. The method of claim 11, wherein the receiving of the request for switching includes:
in response to a user input related to switching to the another interface is made or another external device different from the first external device is connected to the another interface, receiving the request for switching.
